(19) United States
(12) Patent Application Publication
(10) Pub. No.: US 2025/0011231 A1
(43) Pub. Date: Jan. 9, 2025

(54) CONVEYING DEVICE FOR A PLANT FOR THE PRODUCTION OF CEMENT

(71) Applicant: KHD HUMBOLDT WEDAG GmbH, COLOGNE (DE)

(72) Inventor: Matthias MERSMANN, STOLBERG (DE)

(21) Appl. No.: 18/709,399

(22) PCT Filed: Nov. 11, 2022
(86) PCT No.: PCT/EP2022/081627

§ 371 Date: May 10, 2024

(30) Foreign Application Priority Data
Nov. 11, 2021 (DE) 10 2021 129 322.7

(51) Int. Cl. C04B 7/36

(52) U.S. Cl. CPC C04B 7/364; C04B 7/362

(57) ABSTRACT

A conveying device for conveying bulk material for a plant for producing cement clinker, wherein the plant operates in the recirculation process and/or in the oxy-fuel process, and wherein the conveying device has a connection to the plant, in which the bulk material to be transported passes into the plant. A connection between the conveying device and the plant for producing cement clinker has a gas supply for pressurizing the connection with recirculation gas.

### CROSS-REFERENCES TO RELATED APPLICATIONS

This application is a national phase of International Patent Application No. PCT/EP2022/081627, filed on Nov. 11, 2022, which claims the benefit of German Patent Application No. 10 2021 129 322.7, filed on Nov. 11, 2021, the entire disclosures of which are incorporated herein by way of reference.

### FIELD OF THE INVENTION

The invention relates to a conveying device for conveying bulk material for a plant for the production of cement clinker, wherein the plant for the production of cement clinker operates in the recirculation process and/or in the oxy-fuel process, and wherein the conveying device has a connection with the plant for the production of cement clinker, in which bulk material to be transported passes into the plant for the production of cement clinker.

### BACKGROUND OF THE INVENTION

To produce cement clinker, calcareous rock is first ground together with siliceous rock into raw meal and then subjected to heat treatment in an entrained flow reactor in an atmosphere of nitrogen-rich combustion air in a cement clinker production plant. During the heat treatment, carbon dioxide (CO₂) is formally driven out of the calcareous rock from the carbonate (CO₃²⁻) contained in the lime. This heat treatment produces carbon dioxide (CO₂) from two sources, namely from the combustion of fuels, whether renewable or fossil, and from the expulsion of carbon dioxide (CO₂) from the lime (CaCO₃). In order to reduce carbon dioxide emissions into the atmosphere, the first plants are now operated nitrogen-free or at least with a low nitrogen content and carbon dioxide (CO₂) is used as the carrier gas. This changes the solid matter chemistry and the heat balance of this plant. The aim of nitrogen-free or low-nitrogen, but high-carbon dioxide production of cement clinker is to inject the carbon dioxide into underground caverns. The low nitrogen content of the carbon dioxide-rich waste gas to be injected saves considerable compression work.

To provide an exhaust gas enriched with as much CO₂ as possible from a plant for the production of cement clinker, it can be operated in a so-called oxyfuel process. In this process, the carbon dioxide-enriched waste gas from this plant is largely recirculated and enriched with the oxygen required for the combustion processes. The aim is to produce a gas mixture consisting as exclusively as possible of CO₂ and water vapor, and in particular to minimize nitrogen, which is considered a contaminant. In this sense, the ingress of atmospheric air from the environment into the system operated under negative pressure is harmful. The usual proportion of false air in the flue gas of a clinker kiln line downstream of the heat exchanger is between 15% in a properly installed new system and up to 30% in an old system. A not inconsiderable proportion of the atmospheric air enters the kiln system via the flour feed, as on the one hand the transport and dosing devices used there can only be incompletely sealed against the atmospheric ambient air and on the other hand there is also a high proportion of pore volume within the fine bulk material flow that is filled with atmospheric air.

The invention is therefore based on the task of preventing the ingress of false air through the raw meal feed.

### SUMMARY OF THE INVENTION

The problem according to the invention may be solved by a conveyor device with the features according to one or more embodiment described herein.

According to the idea of the invention, it is provided that the connection between the conveying device and the plant for the production of cement clinker has a gas supply for pressurizing the connection with recirculation gas. This gas supply displaces any atmospheric air during the transfer of the bulk material to be conveyed during the transfer to the plant for the production of cement clinker.

In an embodiment of the invention, it may be provided that the conveying device is a bucket elevator which has a feeding device at the outlet, wherein the feeding device has a cross-section which is tapered relative to the central cross-sectional area at the transition to the plant for the production of cement clinker, on which a cone of bulk material is formed during the conveying of the bulk material, which empties into the transition. The cone of bulk material on the tapered cross-section leads to gas separation between the atmospheric ambient air and the recirculation gas in the plant for the production of cement clinker. If the cement clinker production plant is operated under negative pressure, the atmospheric pressure pushes the bulk material through the tapered cross-section of the feeding device so that the bulk material passes through the narrower cross-section as if by suction.

In order to expel atmospheric air trapped in the pores of the bulk material, the gas supply can be arranged so that the recirculation gas flows into the bulk material cone and expels the trapped atmospheric air from the bulk material.

In order to maintain the cone of bulk material as a seal, it may be provided that the conveyor device has a control device that regulates the speed of the bucket elevator depending on the height of the cone of bulk material, whereby the speed of the bucket elevator decreases as the height of the cone of bulk material increases and, conversely, the speed of the bucket elevator increases as the height of the cone of bulk material decreases.

In order to adjust the trickling speed of the bulk material in the transition to the plant for the production of cement clinker, it can be provided that the cross-sectional area of the tapered cross-section can be adjusted from the outside by at least one sliding plate.

In order to remove atmospheric air from the bulk material during the transportation process, a gas supply can be provided to feed the freeboard space of the individual buckets with recirculation gas. The CO₂-rich recirculation gas then settles on the bulk material during transportation of the bulk material in the respective bucket due to its higher density than atmospheric air in the freeboard space and displaces the existing atmospheric air from the pores of the bulk material.

### BRIEF DESCRIPTION OF THE DRAWINGS

The invention is explained in more detail with reference to the following figures.

It shows:

FIG. 1 a first embodiment of the conveying device according to the invention.

### DETAILED DESCRIPTION OF THE PREFERRED EMBODIMENTS

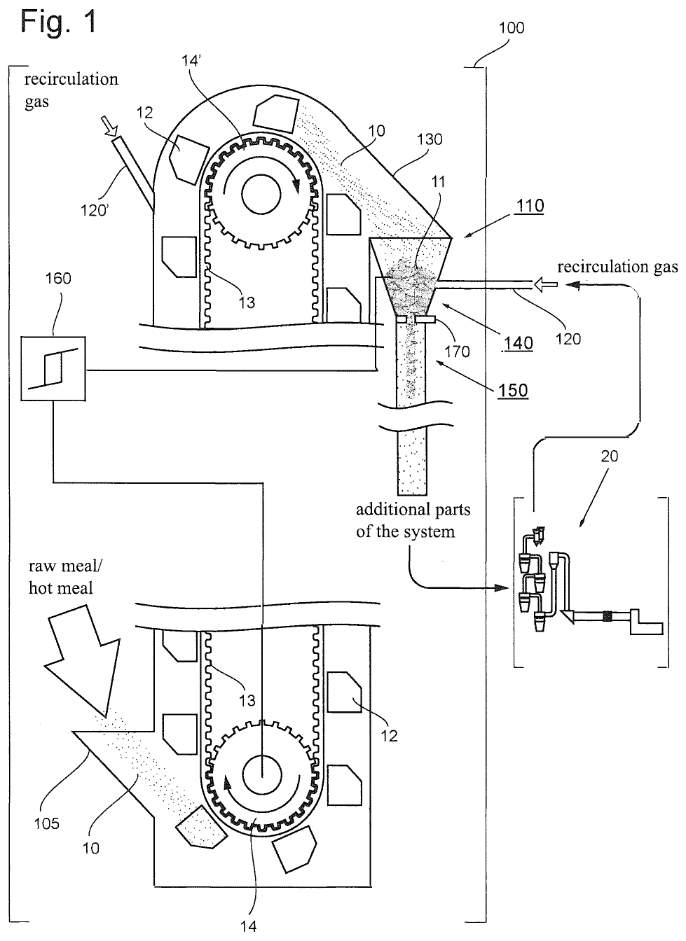

FIG. 1 shows a sketch of a first embodiment of the conveying device 100 according to the invention. This first embodiment of the conveying device 100 is a bucket elevator, which is sketched vertically interrupted in this illustration. At the lower part of the bucket elevator as conveying device 100 there is a bulk material feed 105 for feeding bulk material, in this case raw meal, which is fed onto the bucket elevator as conveying device 100 in an atmospheric air environment. The bucket elevator as conveying device 100 can be enclosed or convey openly. Two deflection rollers 14 and 14′ drive a chain hoist 13 on which individual buckets 12 are arranged and transport the raw meal as bulk material 10 upwards in portions. Arriving at the upper deflection roller 14′, a bucket 12 of the Bucket elevator as conveying device 100 in each case pours out the raw meal as bulk material 10 in the outlet of the bucket elevator as conveying device 100, where the outlet 130 has a connection 110 to a plant 20 for producing cement clinker. On the side of the plant 20, the connection 110 consists of a feeding device 140. The buckets 12 of the bucket elevator as conveying device 100 are emptied into this feeding device 140. The bulk material 10 poured into it forms a bulk material cone 11 in the feeding device 140. This cone 11 of bulk material 10 empties the transition 150 into the plant 20 for the production of cement clinker. According to the idea of the invention, it is provided that recirculation gas is fed from the plant 20 in the region of the connection 110 in order to displace the atmospheric air entrained with the bulk material 10 there. It may be provided that the gas supply 120 displaces the atmospheric air in the region of the connection 110, or it may be provided that the gas supply 120 is offset somewhat further downwards, so that the gas supply 120 opens into the bulk material cone 11 and expels atmospheric air from the pores of the bulk material 10 there. In order to form a cone 11 of bulk material, it is provided that the cross-section of the feeding device 140 tapers so that at the base of the feeding device 140 there is a smaller tapered cross-section VQ than the mean cross-section MQ of the feeding device. The bulk material 10 empties into the system 20 through the smaller, tapered cross-section VQ. In order to adjust the size of the cross-section at the base of the feeding device 140, a sliding plate 170 can be provided, with which the cross-section can be adjusted. A regulating device 160 may be provided which controls the speed and thus the transport capacity of the bucket elevator as conveying device 100, wherein the regulating device reduces the speed of the bucket elevator with increasing height of the bulk material cone 11 and increases it with lower height of the bulk material cone 11. The aim of this control is to maintain the bulk material cone 11 upright and stable, which serves as a gas seal between the atmospheric air of the bucket elevator and the recirculation gas of the system 20. In order to avoid the entry of atmospheric air into the pores of the bulk material cone 11, the gas supply 120 can also introduce the recirculation gas from the system 20 into the bulk material cone 11. In order to remove atmospheric air from the bulk material 10 during the transportation process, it can be provided that a gas supply 120′ feeds the freeboard space of the individual buckets 12 with recirculation gas.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

10 Bulk material
11 Cone
12 Bucket
13 Chain hoist
14 Deflection roller
14′ Deflection roller
20 Plant
100 Conveying device
105 Bulk material feed
110 Connection
120 Gas supply
120′ Gas supply
130 Outlet
140 Feeding device
150 Transition
160 Control device
170 Sliding plate
MQ Average cross-sectional area
VQ Tapered cross section

1.-6. (canceled)

7. A device for conveying bulk material for a plant producing cement clinker, wherein the plant for the production of cement clinker operates in a recirculation process, or an in an oxy-fuel process, or in both, the device comprising:
a connection with the plant, in which a bulk material to be transported passes into the plant, wherein the connection comprises a gas supply for pressurizing the connection with a recirculation gas.

8. The device according to claim 7, wherein the device is a bucket elevator which has a feeding device at an outlet,
wherein the feeding device has a tapered cross-section at a transition to the plant compared to an mean cross-sectional area and on which a cone of the bulk material is formed during conveying of the bulk material, which empties into the transition.

9. The device according to claim 8, wherein the gas supply is arranged such that the recirculation gas flows into the bulk material cone and expels trapped atmospheric air from the bulk material.

10. The device according to claim 8, further comprising:
a regulating device which regulates a speed of the bucket elevator as a function of a height of the cone of bulk material,
wherein the speed of the bucket elevator decreases as the height of the bulk material cone increases and, conversely, the speed of the bucket elevator increases as the height of the bulk material cone decreases.

11. The device according to claim 8, a cross-sectional area of the tapered cross-section is configured to be adjusted from an outside by at least one sliding plate.

12. The device according to claim 7, further comprising a gas supply configured to feed a freeboard space of individual buckets with recirculation gas.
